(19) United States
(12) Patent Application Publication
(10) Pub. No.: US 2024/0319073 A1
(43) Pub. Date: Sep. 26, 2024

(54) INSPECTION CUVETTE AND SYSTEM FOR USE IN THE OPTICAL INSPECTION OF AN OPHTHALMIC LENS

(71) Applicant: Alcon Inc., Fribourg (CH)

(72) Inventors: Felix Brinckmann, Roßdorf (DE); Roger Biel, Aschaffenburg (DE); Daniel Paulus, Miltenberg (DE); Nils Schweizer, Bad König (DE)

(21) Appl. No.: 18/610,384

(22) Filed: Mar. 20, 2024

Related U.S. Application Data
(60) Provisional application No. 63/491,647, filed on Mar. 22, 2023.

(51) Int. Cl. G01N 21/05; G01M 11/02; G01N 21/11

(52) U.S. Cl. CPC G01N 21/05; G01M 11/0214; G01M 11/0278; G01N 21/11; G01N 2021/052

(57) ABSTRACT

An inspection cuvette for the optical inspection of an ophthalmic lens comprises a hollow cuvette body defining a cavity for receiving the ophthalmic lens and an inspection liquid, a transparent bottom having a concave upper surface delimiting the cavity at a bottom end thereof, a handling channel having an inner circumferential channel wall and a longitudinal channel axis. The handling channel further has an access opening at a proximal end thereof and is connected to the cavity at a distal end thereof. The inspection cuvette further comprises and an inspection window comprising a flat lower surface delimiting the cavity at an upper end thereof and facing towards the concave upper surface of the transparent bottom. At least that portion of the inner circumferential channel wall which is arranged above the flat lower surface of the inspection window when the cuvette is arranged in an inspection position is round.

This application claims the benefits under 35 USC § 119 (e) of U.S. provisional application No. 63/491,647, filed on 22 Mar. 2023, incorporated by reference in its entirety.

### FIELD OF THE INVENTION

The present invention generally relates to the field of inspection of ophthalmic lenses in an ophthalmic lens manufacturing line. More specifically, it is related to an inspection cuvette and a system for use in the optical inspection of an ophthalmic lens, in particular a contact lens such as a soft contact lens, in an ophthalmic lens manufacturing line.

### BACKGROUND OF THE INVENTION

Ophthalmic lenses such as contact lenses, for example soft contact lenses, are typically manufactured in large quantities in automated lens manufacturing processes in automated lens manufacturing lines.

In such an automated contact lens manufacturing line, a contact lens may be formed by a molding process using suitable molds. A lens-forming material may be introduced into a female mold half, and the mold is subsequently closed with the corresponding male mold half. The lens-forming material in the closed mold may then be crosslinked and/or polymerized, for example by exposure of the lens-forming material to UV-light or heat, to form a contact lens. Subsequent stations in the automated contact lens manufacturing line may comprise several different lens treatment stations as well as inspection stations, where the finished contact lens is optically inspected.

Optical inspection of the contact lens is performed in order to determine whether the contact lens under inspection meets the required specifications and is free of any defects. Optical inspection may comprise imaging of at least a portion of the contact lens by an optical system. To image the contact lens, the contact lens must be arranged in an optical path of the optical system. Since contact lenses, in particular soft contact lenses, are difficult to handle with mechanical means, they may be immersed in an inspection liquid for the optical inspection. To achieve this, the finished contact lens may be placed in a suitable inspection cuvette filled with an inspection liquid, for example water.

An inspection cuvette suitable for this purpose is disclosed in WO 03/016855. The cuvette shown there comprises a hollow cuvette body that defines a cavity for receiving the ophthalmic lens as well as the inspection liquid. The inspection cuvette further comprises a handling channel having an inner circumferential channel wall and an access opening at a proximal end of the handling channel. At its distal end, the handling channel is connected to the cavity. The inspection cuvette may be pivotally arranged, so that it is arranged either in a handling position or in an inspection position.

In the handling position, the handling channel is arranged vertically above the concave upper surface of the transparent bottom of the inspection cuvette. The contact lens is inserted through the access opening into the inspection liquid contained in the inspection cuvette, for example with the aid of a suitable gripper, and is then released from the gripper to allow the contact lens to settle down in the inspection liquid and come to rest on the concave upper surface of the transparent bottom of the inspection cuvette.

For inspection of the contact lens, the cuvette is then pivoted to the inspection position. Optical inspection of the contact lens may be performed through an inspection window of the inspection cuvette. The inspection window has a flat lower surface delimiting the cavity at an upper end thereof. In the inspection position, the inspection window is arranged vertically above the concave upper surface of the transparent bottom, and optical inspection is performed along an inspection axis normal to the flat lower surface of the inspection window. The inner circumferential wall of the handling channel has a portion that is arranged above the flat lower surface of the inspection window, and the access opening is entirely arranged above the flat lower surface of the inspection window. This allows to fill the inspection cuvette with the inspection liquid to a level such that the flat lower surface of the inspection window is completely immersed in the inspection liquid while the inspection liquid may not leak out from the inspection cuvette through the access opening.

Once optical inspection of the contact lens has been completed, the contact lens needs to be removed from the inspection cuvette. A contact lens meeting the required specifications and free of defects may be transferred to a primary packaging shell with the aid of a gripper, whereas a contact lens not meeting the required specifications or having a defect (or both) remains in the inspection liquid contained in the inspection cuvette and must be removed otherwise. In such instance, removal of the contact lens may be performed in a subsequent cuvette cleaning station, in which the inspection cuvette is cleaned including removal of the inspection liquid and possibly any contact lens contained in the inspection cuvette. Thereafter, the inspection cuvette is filled again with fresh inspection liquid and a new contact lens is inserted for optical inspection.

In the cuvette cleaning station, removal of the inspection liquid and possibly any contact lens from the inspection cuvette may be achieved by the application of vacuum to a suction tube which is introduced into the cavity of the inspection cuvette such that a distal end of the suction tube is immersed in the inspection liquid and is arranged at a small distance above the concave upper surface of the transparent bottom of the inspection cuvette. By means of the vacuum, the contact lens is removed from the cavity through the suction tube together with the inspection liquid. This kind of cuvette cleaning requires vacuum equipment which is complicated (e.g. it requires one or more separators for the liquid and the contact lens), costly, and requires specific maintenance.

As an alternative, it has been suggested that removal of the inspection liquid and the contact lens from the inspection cuvette be performed with the aid of overpressure (instead of suction). This is disclosed, for instance, in WO 2011/045388 A1. As a first step, the opening of the inspection cuvette is closed with a lid or a closure in a pressure-tight manner. Overpressure is then applied via a pressure tube, a portion of which is arranged in the lid or closure. The distal end of the pressure tube is not immersed in the inspection liquid contained in the inspection cuvette. Through the application of overpressure to the interior space of the closed inspection cuvette through the pressure tube, the inspection liquid as well as any contact lens contained in the inspection cuvette is forced through a removal tube, the distal end of which is arranged a small distance above the concave upper surface of the transparent bottom of the inspection cuvette and is immersed in the inspection liquid.

The access opening of the afore-mentioned inspection cuvette as well as a cross-section of the inner circumferential channel wall of the handling channel typically have a rectangular shape, and consequently the handling channel has edges running from the cavity up to the corners of the rectangularly shaped access opening. The filling level of the inspection liquid in the inspection cuvette in the inspection position must be such that the flat lower surface of the inspection window is completely immersed in the inspection liquid. Therefore, a significant portion of the handling channel is filled with the inspection liquid as well. Since the inspection liquid is removed from the inspection cuvette after inspection and new inspection liquid (e.g. water) is filled into the inspection cuvette in each inspection run, the overall water consumption of the inspection stations is comparatively high. Even assuming that the filling volume of one inspection cuvette is about 50 milliliters (ml), and further assuming that 32 inspection cuvettes are filled every 7.5 seconds (cycle time), the water consumption of the inspection stations of a single contact lens manufacturing line during one year (350 days) is about 6.45 m³ (6.45 million liters) of water. In this regard, it should be noted that a production plant typically comprises a plurality of such contact lens manufacturing lines. Obviously, therefore, the overall water consumption is of significant environmental impact and, accordingly, reduction of the water consumption of the inspection station of a contact lens manufacturing line is desirable.

Next, the pivotal movement of the inspection cuvette from the handling position to the inspection position and vice versa results in a sloshing movement of the water in the inspection cuvette. A sloshing movement of the water in the inspection cuvette may also occur when the inspection cuvette is suddenly accelerated to be moved out of one inspection station and is abruptly stopped at the next inspection station. Due to the inner circumferential wall of the handling channel having a rectangular cross section, the sloshing movement of the water in the inspection cuvette may result in some of the water being spilled from the cuvette through the access opening. Obviously, any such spilled water in the manufacturing line is unwanted for many reasons and should therefore be avoided.

Another problem is, that in some instances a contact lens may inadvertently get stuck in one of the edges of the rectangularly shaped inner circumferential wall of the handling channel above the level of the inspection liquid. Although not wishing to be bound by any theory, this may occur during the introduction of the contact lens into the inspection cuvette in case the contact lens does not properly adhere to the gripper, so that the contact lens may be released from the gripper too early and may inadvertently be swirled up to the surface of the inspection liquid and into one of the edges of the inner circumferential wall of the handling channel above the level of the inspection liquid where it may get stuck. Also, it may occur during the transfer of the contact lens to the primary packaging shell in case the contact lens does not properly adhere to the gripper. During the upward movement of the contact lens through the inspection liquid or at the time of passing through the surface of the inspection liquid the contact lens may inadvertently be released from the gripper and may finally get stuck in one of the edges of the circumferential wall.

Obviously, a contact lens that is stuck in one of the edges of the inner circumferential wall of the handling channel above the level of the inspection liquid is not removed from the inspection cuvette in case cuvette cleaning is performed with the aid of vacuum applied to a suction tube the distal end of which is arranged immersed in the inspection liquid (as described above). However, even in case cuvette cleaning is performed with the aid of a lid or closure placed on the access opening and with overpressure being applied to the interior space of the inspection cuvette (as described above), a contact lens that is inadvertently stuck in an edge of the rectangularly shaped inner circumferential wall of the handling channel may not reliably be removed from the inspection cuvette together with the liquid. In any case, such contact lens may then remain in the inspection cuvette and may create a problem when the inspection cuvette is filled with fresh liquid which may cause the said contact lens to move to the cavity of the inspection cuvette again, so that after proper insertion of the next contact lens to be inspected two contact lenses may be contained in the inspection cuvette. In such instance, both contact lenses must be removed from the inspection cuvette and must be sorted out, thus negatively affecting the production yield.

It is therefore an object of the invention to overcome the afore-mentioned disadvantages.

### SUMMARY OF THE INVENTION

In accordance with the present invention, these and other objects are met by an inspection cuvette and a system for use in the optical inspection of an ophthalmic lens, in particular a contact lens such as a soft contact lens, in an ophthalmic lens manufacturing line, as specified by the features of the independent claims. Advantageous aspects of the inspection cuvette and the system according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the term “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, an inspection cuvette for use in the optical inspection of an ophthalmic lens, in particular a contact lens such as a soft contact lens, in an ophthalmic lens manufacturing line is suggested. The inspection cuvette comprises
a hollow cuvette body defining a cavity for receiving the ophthalmic lens as well as an inspection liquid,
a handling channel having an inner circumferential channel wall and a longitudinal channel axis, the handling channel further having an access opening at a proximal end thereof and being connected to the cavity at a distal end thereof, for insertion of the ophthalmic lens into and for removal of the ophthalmic lens from the cavity,
a transparent bottom having a concave upper surface delimiting the cavity at a bottom end thereof, for retaining the ophthalmic lens on the concave upper surface during inspection of the ophthalmic lens immersed in the inspection liquid,
and
an inspection window comprising a flat lower surface delimiting the cavity at an upper end thereof and facing towards the concave upper surface of the transparent bottom, for allowing optical inspection of the ophthalmic lens retained on the concave upper surface of the transparent bottom along an inspection axis normal to the flat lower surface of the inspection window.

When the inspection cuvette is arranged in an inspection position, at least a portion of the inner circumferential channel wall is arranged above the flat lower surface of the inspection window and the access opening is entirely arranged above the flat lower surface of the inspection window, to allow for an arrangement of the access opening above an upper surface of the inspection liquid when the flat lower surface of the inspection window is completely immersed in the inspection liquid.

At least that portion of the inner circumferential channel wall which is arranged above the flat lower surface of the inspection window when the cuvette is arranged in the inspection position is round.

According to one aspect of the inspection cuvette according to the invention, the inner circumferential channel wall has a circular-shaped cross section in a plane normal to the longitudinal channel axis in at least that portion of the inner circumferential channel wall which is arranged above the flat lower surface of the inspection window when the inspection cuvette is arranged in the inspection position.

According to another aspect of the inspection cuvette according to the invention, the access opening has a circular shape.

According to a further aspect of the inspection cuvette according to the invention, when the inspection cuvette is arranged in a handling position, the handling channel and the access opening at the proximal end thereof are arranged vertically above the concave upper surface of the transparent bottom with the longitudinal channel axis running vertically and through the concave upper surface of the transparent bottom. When the inspection cuvette is arranged in the inspection position, the lower surface of the inspection window is arranged vertically above the concave upper surface of the transparent bottom of the inspection cuvette with the inspection axis running vertically and through the concave upper surface of the transparent bottom.

According to yet another aspect of the inspection cuvette according to the invention, the entire inner circumferential channel wall of the handling channel is round.

According to a further aspect of the inspection cuvette according to the invention, the inspection cuvette has a filling volume of less than 45 milliliters, in particular less than 38 milliliters.

According to another aspect of the inspection cuvette according to the invention, the handling channel at its proximal end comprises a circumferential sealing surface allowing to close the access opening in a pressure-tight manner with the aid of a closure.

According to the invention, a system for use in the optical inspection of an ophthalmic lens, in particular a contact lens such as a soft contact lens, in an ophthalmic lens manufacturing line is suggested, too. The system comprises
an inspection cuvette as described above, and
a closure for closing the access opening of the inspection cuvette in a pressure-tight manner along the circumferential sealing surface of the inspection cuvette. The closure comprises a removal tube for removal of the ophthalmic lens together with at least a portion of the inspection liquid from the cavity of the inspection cuvette. A lower end of the removal tube is arranged at a longitudinal distance from the concave upper surface of the bottom of the inspection when the access opening of the inspection cuvette is closed by the closure.

The system according to the invention further comprises a gas inlet for providing pressurized gas to the cavity and/or the handling channel when the access opening of the inspection cuvette is closed by the closure in the pressure-tight manner.

According to one aspect of the system according to the invention, the closure and the access opening are configured to close the access opening of the inspection cuvette in the pressure-tight manner against an overpressure in the inspection cuvette in the range of 0.5 bar to 6 bars.

According to another aspect of the system according to the invention, the system further comprises a source of pressurized gas connected to the gas inlet to provide overpressure to the cavity and/or the handling channel of the inspection cuvette.

According to yet another aspect of the system according to the invention, the gas inlet is incorporated in the closure.

According to yet another aspect of the system according to the invention, the vertical distance at which the lower end of the removal tube is arranged from the concave upper surface of the bottom of the inspection cuvette when the access opening of the inspection cuvette is closed by the closure is in the range between 1 millimeter and 7 millimeters, in particular between 2 millimeters and 4 millimeters.

The term ‘inspection liquid’ described herein denotes any liquid suitable for the inspection of ophthalmic lenses, such as contact lenses and in particular soft contact lenses. By way of example, the inspection liquid may be water.

The terms ‘proximal’ and ‘distal’ are to be understood with respect to a location from which the ophthalmic lenses are inserted into the handling channel.

The term ‘round’ with respect to the shape of the inner circumferential channel wall or a portion thereof is to be understood in a sense such that the slope (or the first derivative) is continuous (i.e. free of any steps or jumps) along the inner circumferential wall. Or to say it in other words, the inner circumferential wall or the respective portion thereof is free of any (inner) edges.

With respect to that portion of the inner circumferential channel wall which is arranged above the flat lower surface of the inspection window when the cuvette is arranged in the inspection position, the round shape is advantageous in that there are no edges where the ophthalmic lens may inadvertently get stuck. Thus, the risk that an ophthalmic lens may still be contained in the inspection cuvette once the cuvette has passed the cuvette cleaning station is eliminated or at least greatly reduced. Even in case an ophthalmic lens may get stuck at the round portion of the inner circumferential channel wall, much more frequently such stuck ophthalmic lens is removed by the airflow generated by the application of overpressure in the cuvette cleaning station when compared to an inspection cuvette having an inner circumferential channel wall with edges. As a consequence, the above-described negative effect on the production yield is either eliminated or at least greatly reduced.

Moreover, the round shape of at least that portion of the inner circumferential channel wall which is arranged above the flat lower surface of the inspection window when the cuvette is arranged in the inspection position also reduces sloshing movement of the inspection liquid inside the handling channel. As already described, sloshing may particularly occur as a consequence of an abrupt movement of the inspection cuvette (regardless of whether the abrupt movement is the pivotal movement of the inspection cuvette from the handling position to the inspection position or vice versa, or is the sudden movement of the inspection cuvette out of one inspection station or the abrupt stop of the inspection cuvette at the subsequent inspection station). In any event, sloshing of the inspection liquid is reduced when compared to an inspection cuvette that has an inner circumferential channel wall with edges in the corresponding portion. In addition, as the level of the inspection liquid in the inspection cuvette is typically comparatively close to the level of the lower boundary of the access opening of the handling channel when the inspection cuvette is arranged in the inspection position, a reduction of the sloshing movement of the inspection liquid also reduces the risk of inspection liquid being spilled from the inspection cuvette through the access opening as the inspection cuvette is pivoted from the handling position to the inspection position.

Furthermore, additional portions of the inner circumferential channel wall or even the entire inner circumferential channel wall may be round as well. Thus, the shape of the cross-section of the inner circumferential channel wall along the longitudinal channel axis may not change. Thereby, a smaller amount of inspection liquid may be needed to completely immerse the inspection window in the inspection liquid when compared to an inspection cuvette having an inner circumferential channel wall with edges (e.g. a handling channel with rectangular cross-section), while maintaining the same minimal inner diameter of the handling channel. Thus, a round inner circumferential channel wall allows to save inspection liquid (e.g. water) in each inspection cycle and thus contributes to a considerably reduced water consumption. This holds even more for embodiments, in which the entire inner circumferential channel wall of the handling channel from the cavity up to the access opening is round.

The inspection window may be made from any material that is suitable to allow for an optical inspection of the ophthalmic lens contained in the cavity of the inspection cuvette through the said inspection window. In particular, the inspection window may be made of glass. Alternatively, the inspection window may be made of a suitable optically transparent plastic material.

As mentioned, the inner circumferential channel wall may have a circular-shaped cross section in a plane normal to the longitudinal channel axis. Or to say it in other words, an inner circumference of the said inner circumferential channel wall delimiting the handling channel in a said plane has a circular shape. The circular shape of the cross-section of the handling channel is advantageous at least in that inspection cuvettes having a correspondingly shaped handling channel are easy and reliable to manufacture. Similarly, the access opening at the proximal end of the handling channel may be of circular shape.

The handling position is that position of the inspection cuvette in which the ophthalmic lens may be inserted into the cavity or removed from cavity through the access opening and the handling channel. When the handling channel and the access opening at the proximal end of the handling channel are arranged vertically above the concave upper surface of the transparent bottom, this allows for an insertion and removal of the ophthalmic lens into and from the cavity along the vertically running longitudinal channel axis. The term ‘vertical’ is to be understood as denoting the direction of gravity. An arrangement ‘vertically above’ is to be understood as describing an arrangement including a vertical displacement but no lateral displacement. Accordingly, an arrangement of the inspection cuvette in the handling position in which the handling channel and the access opening are arranged vertically above the concave upper surface of the transparent bottom allows for an easy insertion of the ophthalmic lens with a gripper along the vertically running longitudinal channel axis.

As regards the arrangement of the lower flat surface of the inspection window vertically above the concave upper surface of the transparent bottom of the inspection cuvette when the inspection cuvette is in the inspection position, such arrangement allows for an optical inspection of the ophthalmic lens along an optical axis running normal to the flat lower surface of the inspection window while this flat lower surface is fully immersed in the inspection liquid, with the ophthalmic lens resting on the concave upper surface of the transparent bottom of the inspection cuvette and facing the flat lower surface of the inspection window.

The afore-described geometries of the inspection cuvette according of the invention allow for reduced amounts of inspection liquid (e.g. water) that need to be filled into the inspection cuvette during each inspection cycle to completely immerse the flat lower surface of the inspection window in the inspection liquid (when the inspection cuvette is arranged in the inspection position). An amount of inspection liquid of less than 45 milliliters, in particular less than 38 milliliters is significantly lower than the amount of inspection liquid of known inspection cuvettes (such as those disclosed in the prior art, see above), which is typically more than 50 milliliters. Therefore, the inspection cuvette according to the invention which needs only a reduced amount of inspection liquid per inspection cycle considerably reduces water consumption, as the water used during each inspection cycle must be removed from the inspection cuvette after the inspection (and is wastewater). Accordingly, the considerably reduced amount of inspection liquid needed per inspection cycle is advantageous both from an economic point of view as well as with a view on environmental protection.

The circumferential sealing surface of the access opening that allows for closing the access opening in a pressure-tight manner with the aid of a closure is advantageous since removal of the inspection liquid and possibly of an ophthalmic lens that has not successfully passed inspection from the cavity of the inspection cuvette may be performed by applying overpressure through the closure to the handling channel and/or the cavity (or in use to the inspection liquid contained therein). The application of overpressure in combination with the round geometry of the inner circumferential wall of the handling channel (or at least of that portion of the inner circumferential wall that is located above the flat lower surface of the inspection window) is advantageous in that the inspection liquid and possibly an ophthalmic lens may be reliably removed from the inspection cuvette. Even in cases in which an ophthalmic lens has inadvertently got stuck to that portion of the inner circumferential wall of the handling channel that is arranged above the flat lower surface of the inspection window (i.e. above the level of the inspection liquid in the handling channel), the overpressure may reliably remove the ophthalmic lens from the inspection cuvette due to the round geometry of the inner circumferential wall in that portion.

For applying the overpressure, the closure closes the access opening of the inspection cuvette in a pressure-tight manner by sealing the handling channel at the sealing surface at the proximal end of the handling channel. The inspection window and the transparent bottom (e.g. in case this bottom is embodied as a separate element and is mounted to the cuvette body) may be mounted to the cuvette body in a pressure-tight manner, too. Thereby, the whole interior space of the cuvette may then be closed in a pressure-tight manner, except for dedicated interfaces, such as the distal end of a removal tube through which the inspection liquid and possibly an ophthalmic lens are removed from the inspection cuvette.

As long as there is no closure at the access opening, the cavity of the inspection cuvette can be accessed via the handling channel without any obstructions, i.e. inspection liquid can be filled in, an ophthalmic lens can be placed into or removed from the cavity with the aid of a gripper, etc. When the access opening is closed by the closure, the cavity is not connected to the exterior anymore except via the gas inlet and the removal tube, in case airflow therethrough is admitted. The gas inlet may be incorporated in the closure or may alternatively be arranged at a different location of the handling channel at a level above the level of the flat lower surface of the inspection window. The removal tube extends through the closure and comprises a lower end which, when the access opening is closed by the closure, may be arranged inside the handling channel and also partly inside the cavity of the inspection cuvette. By way of example, the removal tube may have an inner diameter in the range of 2 millimeters to 6 millimeters. When the closure closes the access opening, the lower end of the removal tube may be arranged at a longitudinal distance in the range between 1 millimeter and 7 millimeters, in particular between 2 millimeters and 4 millimeters, from the concave upper surface of the transparent bottom of the inspection cuvette. This distance is the distance between the lowermost location on the concave upper surface and the distal end of the removal tube, and is measured in the direction of the longitudinal channel axis.

The closure and the access opening are configured to be pressure-tight at least with respect to an overpressure in the range of 0.5 bar to 6 bars. This is advantageous in that an overpressure in the said range may actually be applied to the cavity of the handling channel without any gas leaking out. Said pressure range is advantageous in that it generates a sufficient force to cause the inspection liquid to flow from the cavity into the removal tube, and to possibly remove an ophthalmic lens (if present) with a very high probability. At the same time, a pressure in the said range does not generate too high forces acting on the cuvette body or the inspection window.

A source of pressurized gas may be connected to the gas inlet to provide the overpressure. An example for the pressurized gas is pressurized air.

### BRIEF DESCRIPTION OF THE DRAWINGS

Further advantageous aspects of the invention become apparent from the following description of embodiments of the invention with the aid of the (schematic) drawings, in which:

FIG. 1 shows a perspective view of an embodiment of the inspection cuvette according to the invention in a handling position;

FIG. 2 shows a top view of the embodiment of the inspection cuvette shown in FIG. 1;

FIG. 3 shows a cross-sectional view along line III-III of FIG. 2;

FIG. 4 shows a perspective view of the embodiment of the inspection cuvette of FIG. 1 in an inspection position;

FIG. 5 shows a top view of the embodiment of the inspection cuvette shown in FIG. 4;

FIG. 6 shows cross-sectional view along line VI-VI of FIG. 5;

FIG. 7 shows a top view of an embodiment of a system according to the invention, with the inspection cuvette in the handling position;

FIG. 8 shows a perspective view of the embodiment of the system shown in FIG. 7;

FIG. 9 shows a cross-sectional view along line IX-IX of FIG. 7;

FIG. 10 shows a perspective view of an embodiment of the inspection cuvette according to the invention (right-hand side) together with an inspection cuvette according to the prior art (left-hand side), both in an inspection position;

FIG. 11 shows a top view of the embodiment of the inspection cuvette shown in FIG. 10, but in a different rotational orientation than in FIG. 10;

FIG. 12 shows a cross-sectional view along line XII-XII of FIG. 11.

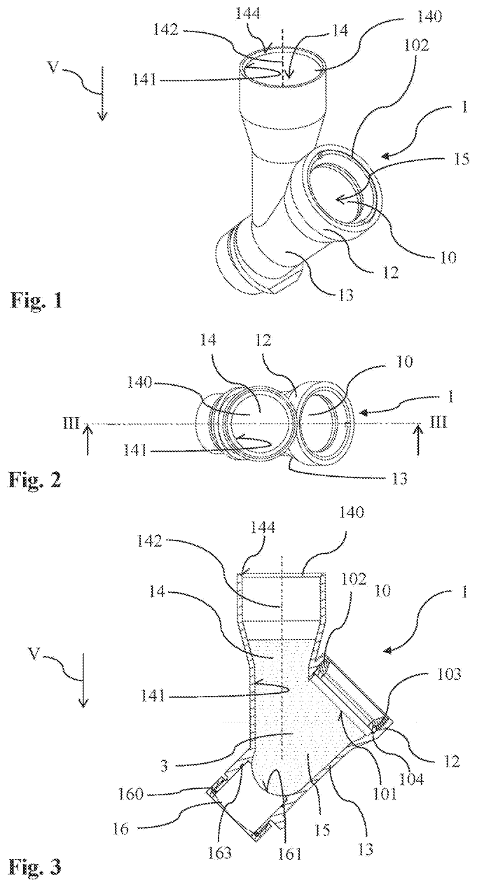

FIG. 1-FIG. 3 schematically show an embodiment of the inspection cuvette 1 according to the invention in a handling position, in a perspective view, a top view and a cross-sectional view. Inspection cuvette 1 comprises a hollow cuvette body 13 defining a cavity 15 for receiving an ophthalmic lens, for example a soft contact lens 4, as well as an inspection liquid 3. By way of example, cuvette body 13 is made of a plastic material. Inspection cuvette 1 further comprises an inspection window 10 which is arranged at an inspection port 12 and retained therein with a retainer ring 102. By way of example, inspection window 10 is made of glass. Inspection cuvette 1 further comprises a handling channel 14 having a longitudinal channel axis 142 as well as an inner circumferential channel wall 141. Handling channel 14 comprises an access opening 140 at a proximal end of the handling channel 14. In the handling position of inspection cuvette 1 shown in FIG. 1-FIG. 3, the longitudinal channel axis 142 of handling channel 14 runs vertically, i.e. longitudinal channel axis 142 is aligned with a vertical axis V, and vertical axis V runs in the direction of gravity. Access opening 140 faces vertically upwards. The inspection cuvette 1 may be arranged on a pivotable mount (not shown) to allow the inspection cuvette 12 to be arranged either in the handling position or in an inspection position by pivoting the inspection cuvette 1 between these two positions.

In the handling position, soft contact lens 4 can be inserted into and removed from the cavity 15 from the top along the vertical axis V through access opening 140 and handling channel 14, for example with the aid of a gripper (not shown). Access opening 140 has a circular shape, and inner circumferential channel wall 141 has a circular shape, too. In other words, inner circumferential channel wall has a circular-shaped cross section in a plane normal to longitudinal channel axis 142 (which corresponds to the drawing plane of FIG. 2).

Inspection cuvette 1 further comprises a transparent bottom 16 (i.e. bottom 16 is optically transparent). Transparent bottom 16 has a concave upper surface 161. In the embodiment shown, transparent bottom 16 is formed by a separate component which may be made of glass and which is threadedly mounted to the lower end of cuvette body 13 with the aid of a corresponding threaded mounting element 160, and is sealingly mounted to cuvette body 13 with the aid of a sealing ring 163. In the embodiment shown, the entire inner circumferential channel wall 141 of handling channel 14 has a circular cross section with respect to a plane normal to the longitudinal channel axis 142. Handling channel 14 and access opening 140 are arranged vertically above concave upper surface 161 of transparent bottom 16. Accordingly, longitudinal channel axis 142 runs vertically and through concave upper surface 161 of the transparent bottom 16. Inspection cuvette 1 is filled with the inspection liquid 3, e.g. water, such that the cavity 15 is completely filled with the inspection liquid 3 and handling channel 14 is partly filled with the inspection liquid 3. Inspection window 10 has a flat lower surface 101 facing towards the concave upper surface 161, and is entirely immersed in the inspection liquid 3. The inspection window 10 is mounted to the inspection port 12 in a leak-tight manner with the aid of retainer ring 102, washer 103 and sealing ring 104

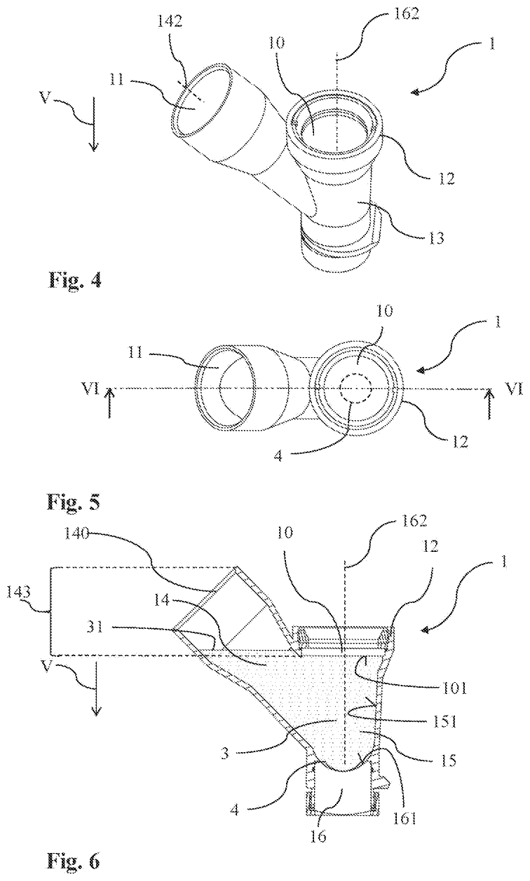

FIG. 4-FIG. 6 schematically show a perspective view, a top view, and a cross-sectional view, of the embodiment of the inspection cuvette 1 shown in FIG. 1-FIG. 3 in an inspection position. In the inspection position, an inspection axis 162—which is the axis along which inspection of soft contact lens 4 is performed—runs vertically, i.e. in direction of the vertical axis V, whereas longitudinal channel axis 142 runs at an inclination relative to the vertical axis V. The inspection window 10 points vertically upwards. Inspection of the soft contact lens 4 along the inspection axis 162 may be performed with the aid of a light source (not shown) arranged beneath the transparent bottom 16 of inspection cuvette 1, and further with the aid of a camera (not shown) arranged above the inspection window 10. During inspection, the soft contact lens 4 is arranged on the concave upper surface 161 of transparent bottom 16.

During inspection of the soft contact lens 4, the cavity 15 is filled with the inspection liquid 3 to a level such that the flat lower surface 101 of the inspection window 10 is completely immersed in the inspection liquid 3. The amount of inspection liquid 3 needed may be less than 45 milliliters, in particular less than 38 milliliters. By immersing the flat lower surface 101 completely in the inspection liquid 3 it is avoided that the image of the soft contact lens 4 recorded by the camera is affected by any irregularities of the surface 31 of the inspection liquid 3. In the inspection position, access opening 140 of handling channel 14 is entirely arranged above the flat lower surface 101 of the inspection window 10, and also above the surface 31 of the inspection liquid 3. while the flat lower surface 101 of the inspection window 10 is completely immersed in the inspection liquid 3. As mentioned already, the entire inner circumferential channel wall 141 of handling channel 14 is round (here: circular), although in principle only that portion 143 of the inner circumferential channel wall 141 which is arranged above the flat lower surface 101 of the inspection window 10 needs to be round.

In case inspection of soft contact lens 4 has resulted in soft contact lens 4 being determined to comply with the specifications/requirements, soft contact lens 4 may be removed from the inspection cuvette 1 and transferred to a primary packaging shell with the aid of a gripper (not shown), as is known in the art. Inspection cuvette 1 may subsequently be returned for the next inspection cycle. A cuvette cleaning station may be arranged in the return path, in which the used inspection liquid 3 is removed from inspection cuvette 1. Thereafter, fresh inspection liquid 3 is filled into inspection cuvette 1, and the next soft contact lens 1 to be inspected is introduced into inspection cuvette 1 filled with fresh inspection liquid 3, for example with the aid of a gripper, as is also known in the art. However, in case inspection of soft contact lens 4 has resulted in soft contact lens 4 being determined not to comply with the specifications/requirements, then soft contact lens 4 is not transferred to the primary packaging shell but remains in the inspection cuvette 1. In such case, soft contact lens 4 must be removed from inspection cuvette 1 in the cuvette cleaning station together with the inspection liquid 3. This removal may be performed as described in the following.

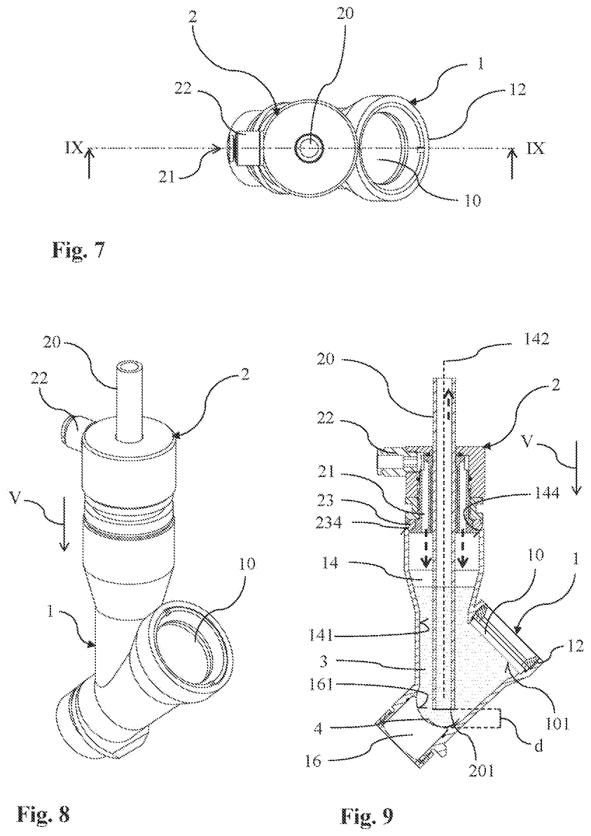

FIG. 7-FIG. 9 schematically show an embodiment of a system according to the invention, in a top view, a perspective view and a cross-sectional view. The system comprises the inspection cuvette 1 and a closure 2 for closing the access opening 140 of handling channel 14 of inspection cuvette 1 in a pressure-tight manner. During removal of the inspection liquid 3 and possibly the soft contact lens 4 from the inspection cuvette 1, closure 2 actually closes the access opening 140, with the inspection cuvette being arranged in the handling position (see FIG. 1-FIG. 3). The system further comprises a gas inlet 21, which—in the embodiment shown—is incorporated in closure 2. A connector 22 of a tube (not shown) is connected to gas inlet 21 (which comprises both a socket for accommodating the connector 22 as well as a ring-shaped channel extending downwardly). The tube in turn is connected to a source of pressurized gas (not shown). By way of example, the source of pressurized gas may provide the gas at an overpressure in the range of 0.5 bar to 6 bars. Closure 2 further comprises a removal tube 20 through which the inspection liquid 3 (and possibly the soft contact lens 4) may be removed from the cavity 15 of the inspection cuvette 1.

Closure 2 further comprises a sealing ring 23 running circumferentially about a distal portion of the closure 2. Sealing ring 23 comprises an outer circumferential sealing surface 234 which, in the assembled state (i.e. when the closure 2 closes the access opening 140 of handling channel 14 of inspection cuvette 1), sealingly engages the circumferential sealing surface 144 at the proximal end of handling channel 14 of inspection cuvette 1. The sealing engagement of outer circumferential sealing surface 234 of sealing ring 23 and circumferential sealing surface 144 at the proximal end of the handling channel 14 ensures that access opening 140 is closed in a pressure-tight manner.

Removal tube 20 extends vertically through the closure 2 and along the longitudinal channel axis 142 into the cavity 15 of the inspection cuvette 1. As can be seen in FIG. 9, a lower portion of the removal tube 20 is immersed in the inspection liquid 3. A lower end 201 of the removal tube 20 is arranged at a longitudinal distance d from the concave upper surface 161 of the transparent bottom 16. The longitudinal distance d is measured in the direction of the longitudinal channel axis 142 and is the distance between the lowermost point of the concave upper surface 161 when the inspection cuvette 1 is in the handling position, and the lower end 201 of removal tube 20.

For the removal of the inspection liquid 3 and possibly the soft contact lens 4 from the inspection cuvette 1, overpressure is applied through gas inlet 21 into a portion of handling channel 14 arranged above the surface of the inspection liquid 3. As a consequence, the inspection liquid 3 and, if present, the soft contact lens 4 is/are pressed through the removal tube 20 (see dashed arrows in FIG. 9). The remote end of removal tube 20 (not shown in FIG. 9) may be connected to a sieve, mesh or filter to separate the soft contact lens 4 (if any) from the inspection liquid 3 and retain it in the sieve, mesh or filter, while the removed inspection liquid 3 may be connected to a waste liquid system or container.

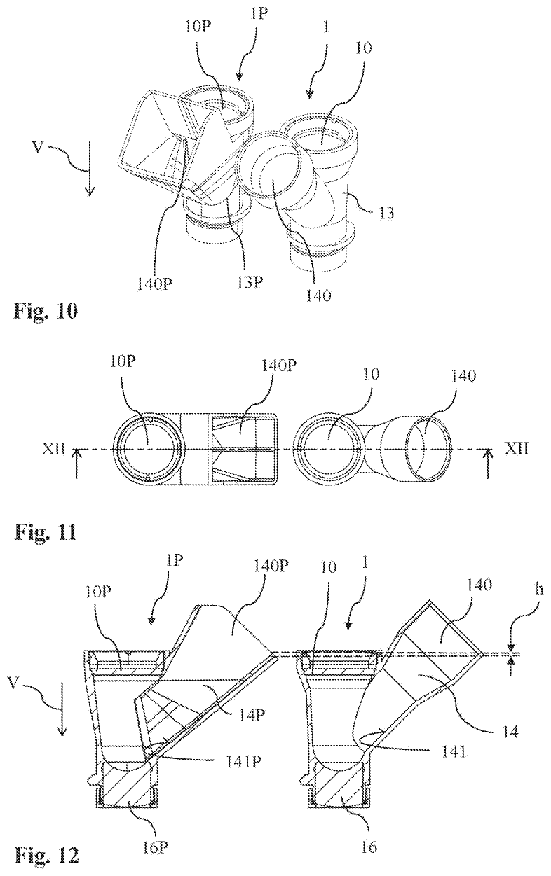

FIGS. 10-FIG. 12 schematically show the embodiment of the inspection cuvette 1 according to the invention (as shown in FIGS. 1 to 6) as well as an inspection cuvette 1P of the prior art, in a perspective view, a top view and a cross-sectional view. The letter ‘P’ indicates that it relates to a feature of the inspection cuvette of the prior art (for example, the inspection cuvette 1P is that of the prior art) The embodiment of the inspection cuvette 1 according to the invention as well as the inspection cuvette 1P of the prior art are arranged in the inspection position. The comparison shows that although the access opening 140P of the inspection cuvette 1P and the access opening 140 of the inspection cuvette of the embodiment of the inspection cuvette according to the invention have a comparable minimal diameter, the cross-sectional area of the access opening 140P of the inspection cuvette 1P is significantly larger than the corresponding cross-sectional area of the access opening 140 of the embodiment of the inspection cuvette 1 according to the invention. This difference contributes to a reduced water consumption of the inspection cuvette 1 according to the invention compared to the inspection cuvette 1P of the prior art.

Cuvette body 13 of inspection cuvette 1 according to the invention and cuvette body 13P of the inspection cuvette 1P of the prior art are basically very similar, such that more expensive components (like inspection window 10P and bottom glass 16P) that are used in the inspection cuvette 1P of the prior art can also be used in the inspection cuvette 1 according to the invention without any changes thereto.

Another difference between the inspection cuvette 1 according to the invention and the inspection cuvette 1P of the prior art can be seen best in FIG. 12. When the respective inspection cuvettes 1 and 1P are in the inspection position, the respective lowest point of the access opening 140 at the proximal end of handling channel 14 is arranged at a vertical position that differs by a vertical height h from the vertical position of the access opening 140P at the proximal end of handling channel 14P. This difference in vertical height h further reduces the risk of inspection liquid 3 being spilled through the access opening 140 as a result of an abrupt movement of the inspection cuvette 1 (pivotal movement or other movement). Also, from FIG. 12 the reduced inner volume of handling channel 14 and the reduced amount of inspection liquid 3 required becomes more evident.

Embodiments of the invention have been described with the aid of the drawings. However, the invention is not limited to these embodiments, but rather many changes and modifications are possible without departing from the teaching underlying the instant invention. Therefore, the scope of protection is defined by the appended claims.

1. Inspection cuvette (1) for use in the optical inspection of an ophthalmic lens (4), in particular a contact lens (4) such as a soft contact lens (4), in an ophthalmic lens manufacturing line, the inspection cuvette (1) comprising:
a hollow cuvette body (13) defining a cavity (15) for receiving the ophthalmic lens (4) as well as an inspection liquid (3),
a handling channel (14) having an inner circumferential channel wall (141) and a longitudinal channel axis (142), the handling channel (14) further having an access opening (140) at a proximal end thereof and being connected to the cavity (15) at a distal end thereof, for insertion of the ophthalmic lens (4) into and for removal of the ophthalmic lens (4) from the cavity (15),
a transparent bottom (16) having a concave upper surface (161) delimiting the cavity (15) at a bottom end thereof, for retaining the ophthalmic lens (4) on the concave upper surface (161) during inspection of the ophthalmic lens (4) immersed in the inspection liquid (3),
and
an inspection window (10) comprising a flat lower surface (101) delimiting the cavity (15) at an upper end thereof and facing towards the concave upper surface (161) of the transparent bottom (16), for allowing optical inspection of the ophthalmic lens (4) retained on the concave upper surface (161) of the transparent bottom (16) along an inspection axis (162) normal to the flat lower surface (101) of the inspection window (10),
wherein, when the inspection cuvette (1) is arranged in an inspection position, at least a portion of the inner circumferential channel wall (14) is arranged above the flat lower surface (101) of the inspection window (10) and the access opening (3) is entirely arranged above the flat lower surface (101) of the inspection window (10), to allow for an arrangement of the access opening (140) above an upper surface of the inspection liquid (3) when the flat lower surface (101) of the inspection window (10) is completely immersed in the inspection liquid (3),
characterized in that at least that portion of the inner circumferential channel wall (141) which is arranged above the flat lower surface (101) of the inspection window (10) when the cuvette (1) is arranged in the inspection position is round.

2. Inspection cuvette according to claim 1, wherein the inner circumferential channel wall (141) has a circular-shaped cross section in a plane normal to the longitudinal channel axis (142) in at least that portion of the inner circumferential channel wall (141) which is arranged above the flat lower surface (101) of the inspection window (10) when the inspection cuvette (1) is arranged in the inspection position.

3. Inspection cuvette according to claim 2, wherein the access opening (140) has a circular shape.

4. Inspection cuvette according to claim 1, wherein, when the inspection cuvette (1) is arranged in a handling position, the handling channel (14) and the access opening (140) at the proximal end thereof are arranged vertically above the concave upper surface (161) of the transparent bottom (16) with the longitudinal channel axis (142) running vertically and through the concave upper surface (161) of the transparent bottom (16), and wherein, when the inspection cuvette (1) is arranged in the inspection position, the lower surface (101) of the inspection window (10) is arranged vertically above the concave upper surface (161) of the transparent bottom (16) of the inspection cuvette (1) with the inspection axis (162) running vertically and through the concave upper surface (161) of the transparent bottom (16).

5. Inspection cuvette according to claim 1, wherein the entire inner circumferential channel wall (141) of the handling channel (14) is round.

6. Inspection cuvette according to claim 1, wherein the inspection cuvette (1) has a filling volume of less than 45 milliliters, in particular less than 38 milliliters.

7. Inspection cuvette according to claim 1, wherein the handling channel (14) at its proximal end comprises a circumferential sealing surface (144) allowing to close the access opening (10) in a pressure-tight manner with the aid of a closure.

8. System for use in the optical inspection of an ophthalmic lens (4), in particular a contact lens (4) such as a soft contact lens, in an ophthalmic lens manufacturing line, the system comprising:
an inspection cuvette (1) according to claim 7,
a closure (2) for closing the access opening (11) of the inspection cuvette (1) in a pressure-tight manner along the circumferential sealing surface (144) of the inspection cuvette (1), the closure (2) comprising a removal tube (20) for removal of the ophthalmic lens (4) together with at least a portion of the inspection liquid (3) from the cavity (15) of the inspection cuvette (1), wherein a lower end (201) of the removal tube (20) is arranged at a longitudinal distance (d) from the concave upper surface (161) of the bottom (16) of the inspection cuvette (1) when the access opening (11) of the inspection cuvette (1) is closed by the closure (2), and
a gas inlet (21) for providing pressurized gas to the cavity (15) and/or the handling channel (14) when the access opening (11) of the inspection cuvette (1) is closed by the closure (2) in the pressure-tight manner.

9. System according to claim 8, wherein the closure (2) and the access opening (11) are configured to close the access opening (11) of the inspection cuvette (1) in the pressure-tight manner against an overpressure in the inspection cuvette (1) in the range of 0.5 bar to 6 bars.

10. System according to claim 9, further comprising a source of pressurized gas connected to the gas inlet (21) to provide overpressure to the cavity (14) and/or the handling channel (15) of the inspection cuvette (1).

11. System according to claim 8, wherein the gas inlet (21) is incorporated in the closure (2).

12. System according to claim 8, wherein the longitudinal distance (d) at which the lower end (201) of the removal tube (20) is arranged from the concave upper surface (161) of the bottom (16) of the inspection cuvette (1) when the access opening (11) of the inspection cuvette (1) is closed by the closure (2) is in the range between 1 millimeter and 7 millimeters, in particular between 2 millimeters and 4 millimeters.
